(19) United States
(12) Patent Application Publication
(10) Pub. No.: US 2024/0308648 A1
(43) Pub. Date: Sep. 19, 2024

(54) FLY-BY-WIRE FLIGHT CONTROL SYSTEM WITH BACK-UP CONTROL IN AN INCEPTOR

(71) Applicant: HONEYWELL INTERNATIONAL INC., Charlotte, NC (US)

(72) Inventors: Tousif Dange, Bangalore (IN); Jyotisankar Panda, Bangalore (IN); Vignesh S, Bangalore (IN); Shiksha S Murthy, Bangalore (IN)

(73) Assignee: HONEYWELL INTERNATIONAL INC., Charlotte, NC (US)

(21) Appl. No.: 18/311,690

(22) Filed: May 3, 2023

(30) Foreign Application Priority Data
Mar. 16, 2023 (IN) 202311017760

(51) Int. Cl. B64C 13/50

(52) U.S. Cl. CPC B64C 13/503; B64C 13/505

(57) ABSTRACT

A fly-by-wire flight control system includes a plurality of effector control electronics, a plurality of flight control computers, and an inceptor. Each effector control electronics receives effector-specific flight control command data and generates and supplies flight control surface commands to one or more flight control effectors. Each flight control computer receives inceptor command selectively generates and supplies the effector-specific flight control command data. The inceptor supplies the inceptor data to the flight control computers. The inceptor also includes a backup flight control processor that is configured to: receive a backup control mode signal indicating that the flight control computers are inoperable; and in response to the backup control mode signal, to selectively generate and supply the effector-specific flight control command data.

### CROSS REFERENCE TO RELATED APPLICATION

The present application claims benefit of prior filed India Provisional Patent Application No. 202311017760, filed Mar. 16, 2023, which is hereby incorporated by reference herein in its entirety.

### TECHNICAL FIELD

The present disclosure relates to fly-by-wire flight control systems and, more particularly, to a fly-by-wire flight control system with backup control in an inceptor.

### BACKGROUND

Typical fly-by-wire flight control systems include redundant flight control computers. The redundant flight control computers receive control commands from inceptors, various sensor signals, and effector feedback. In response, the redundant flight control computers command the effector control electronics to control various effectors and thus aircraft control surfaces and/or propellors. In many instances, a backup control mechanism is required in the unlikely, yet postulated event of a loss of normal functionality of the redundant flight control computers. It is postulated that the loss of normal functionality of the flight control computers could be due to, for example, degraded sensors data, power failures, device failures, or common mode failures, just to name a few. Regardless of the cause, the backup control mechanism needs to at least provide the minimal functionality to fly and land the vehicle.

Various systems and methods have been implemented to provide the backup control mechanism. One example backup control mechanism is a mechanical backup system. This system is automatically coupled into the control system through locking actuators that release a coupling mechanism and clamp or lock pilot input to the mechanical control loop, thus providing direct mechanical control to the surface actuators with very little transient effects. This system, unfortunately, requires a significant amount of weight, space, power, and size.

Another example backup control mechanism relies on two distributed flight control systems—a primary flight control system and a simple backup flight control system, which are independent and dissimilar. In the unlikely event of the loss of the primary control system, the backup flight control system provides the ability to safely fly and land the aircraft. This too exhibits drawbacks, such as the additional backup flight control computer and associated wiring from various interfacing systems, which can also increase overall weight, size, and cost.

Yet another example backup control mechanism is hosting the backup control in one of the redundant flight control computers. However, if the flight control computer that is hosting the backup control is lost, then the backup control is simultaneously lost.

Hence, there is a need of providing a backup control mechanism for a fly-by-wire flight control system that does not significantly increase over system weight, space, power, size, and cost, and that is not susceptible to being lost simultaneously with the loss of a flight control computer. The present disclosure addresses at least these needs.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a fly-by-wire flight control system includes a plurality of effector control electronics, a plurality of flight control computers, and an inceptor. Each effector control electronics is coupled to selectively receive effector-specific flight control command data, and each effector control electronics is configured, upon receipt of its effector-specific flight control command data, to generate and supply flight control surface commands to one or more flight control effectors. Each flight control computer is coupled to receive inceptor command data and is configured, upon receipt of the inceptor data, to at least selectively generate and supply the effector-specific flight control command data. The inceptor is in operable communication with each effector control electronics and each flight control computer and is configured to supply the inceptor data to the flight control computers. The inceptor includes a backup flight control processor that is further configured to: receive a backup control mode signal indicating that the flight control computers are inoperable; and in response to the backup control mode signal, to selectively generate and supply the effector-specific flight control command data.

In another embodiment, a vehicle includes a vehicle body and a fly-by-wire flight control system disposed within the vehicle body. The fly-by-wire flight control system includes a plurality of effector control electronics, a plurality of flight control computers, and an inceptor. Each effector control electronics is coupled to selectively receive effector-specific flight control command data, and each effector control electronics is configured, upon receipt of its effector-specific flight control command data, to generate and supply flight control surface commands to one or more flight control effectors. Each flight control computer is coupled to receive inceptor command data and is configured, upon receipt of the inceptor data, to at least selectively generate and supply the effector-specific flight control command data. The inceptor is in operable communication with each effector control electronics and each flight control computer and is configured to supply the inceptor data to the flight control computers. The inceptor includes a backup flight control processor that is further configured to: receive a backup control mode signal indicating that the flight control computers are inoperable; and in response to the backup control mode signal, to selectively generate and supply the effector-specific flight control command data.

In yet another embodiment, a fly-by-wire flight control system includes a plurality of effector control electronics, a plurality of flight control computers, and an inceptor. Each effector control electronics is coupled to selectively receive effector-specific flight control command data. Each effector control electronics is configured, upon receipt of its effector-specific flight control command data, to generate and supply flight control surface commands to one or more flight control effectors. Each flight control computer is coupled to receive inceptor command data and is configured, upon receipt of the inceptor data, to at least selectively generate and supply the effector-specific flight control command data. The inceptor is in operable communication with each effector control electronics and each flight control computer and is configured to supply the inceptor data to the flight control computers. The inceptor includes a backup flight control processor that is configured to: (i) receive a backup control mode signal indicating that the flight control computers are inoperable and (ii) in response to the backup control mode signal, to selectively generate and supply the effector-specific flight control command data. Each effector control electronics is further configured to (i) determine that the flight control computers are inoperable (ii) select the flight control commands from the inceptor in backup control mode and otherwise select from the flight control computers, (iii) synchronize the commands with other effector control electronics if required, and (iv) monitor closed loop control.

Furthermore, other desirable features and characteristics of the fly-by-wire flight control system will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a functional block diagram of one embodiment of an aircraft fly-by-wire flight control system; and

FIG. 2 depicts a functional block diagram of another embodiment of an aircraft fly-by-wire flight control system.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

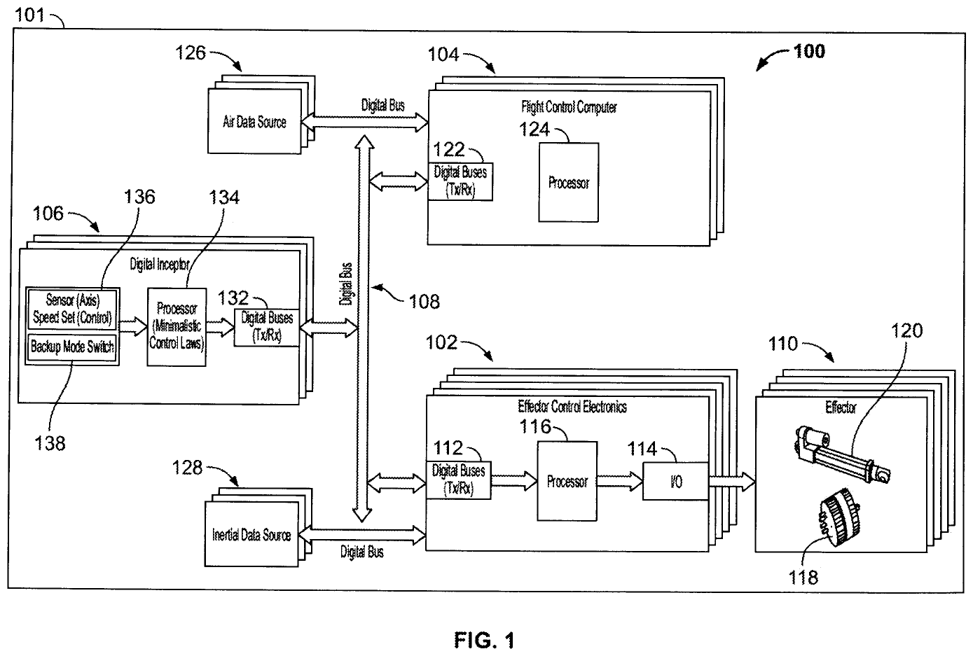

Referring to FIG. 1, a functional block diagram of one embodiment of a fly-by-wire flight control system 100 is depicted and includes a plurality of effector control electronics 102, a plurality of flight control computers 104, and at least one inceptor 106, all of which are disposed within a body 101 of a vehicle. As FIG. 1 also depicts, the effector control electronics 102, the flight control computers 104, and the one or more inceptors 106 are all in operable communication via a digital communication bus 108. It will be appreciated that the configuration and specific protocol of the digital communication bus 108 may vary. For example, the digital communication bus 108 may be implemented using a CAN (Controller Area Network) bus or a TTP (Time-Triggered Protocol) bus, just to name a few non-limiting examples.

No matter how the digital communication bus 108 is specifically implemented, each effector control electronics 102 is coupled to selectively receive, via the digital communication bus 108, effector-specific flight control surface effector command data. Each effector control electronics 102 is configured, upon receipt of its effector-specific flight control command data, to generate and supply flight control commands to one or more flight control effectors 110. As used herein, a “flight control effector” is any physical device that is able to generate control forces and/or moments on a vehicle, in a sufficiently small time span, to thereby maneuver the vehicle.

Although the effector control electronics 102 may be variously configured, in the depicted embodiment, each includes suitable digital bus transceiver 112, a suitable input/output (I/O) interface 114, and an effector processor 116. The digital bus transceiver 112, which may be implemented using any one of numerous suitable transceivers, is configured to facilitate communication with the digital communication bus 108. The I/O interface 114, which may be implemented using any one of numerous suitable interfaces, is configured to facilitate communication with the associated flight control effectors 110. The effector processor 116 is configured to implement an actuator control law that is suitable for the associated flight control effectors 110. The effector processor 116 may be implemented using suitably programmed general-purpose processor, an application specific processor, a programmable logic device (PLD), or a field programmable gate array (FPGA), just to name a few non-limiting examples.

It will be appreciated that the flight control effectors 110 may be variously configured and implemented. In the depicted embodiment, the flight control effectors 110 are electromechanical actuators. Thus, as FIG. 1 further depicts, each includes an electric motor 118 and an actuator 120. As is generally known, the electric motor 118 is configured, upon being electrically energized (via its associated effector control electronics 102), supplies a drive torque to the actuator 120. Though not specifically depicted in FIG. 1, it will be appreciated that the flight control effectors 110 may also be configured to supply feedback (e.g., position feedback) to the associated effector control electronics 102.

Before proceeding further, it should be noted that when the flight control effectors 110 are implemented with electric motors, the effector control electronics 102 may, in some embodiments, also be referred to as flight control motor effectors.

Returning now to the description, each flight control computer 104 is coupled to receive inceptor command data and is configured, upon receipt of the inceptor data, to at least selectively generate and supply the effector-specific flight control command data. It will be appreciated that the flight control system 100 may be configured such that one or all of the flight control computers 104 may be active and may thus supply the effector-specific flight control command data. In some embodiments, only one of the flight control computers 104 may be active to supply the effector-specific flight control command data, while the others are in a backup mode and only become active if the currently active flight control computer 104 becomes inoperable. Although the flight control computers 104 may be variously configured, in the depicted embodiment, each includes a suitable digital bus transceiver 122 and a flight control processor 124.

The digital bus transceiver 122, which may be implemented using any one of numerous suitable transceivers, is configured to facilitate communication with the digital communication bus 108. The flight control processor 124 is configured to implement a flight control surface control algorithm. The flight control processor 124 may be implemented using suitably programmed general-purpose processor, an application specific processor, a programmable logic device (PLD), or a field programmable gate array (FPGA), just to name a few non-limiting examples. In the depicted embodiment, the flight control processor is implemented using a dual lockstep processor.

It will be appreciated that the flight control effector algorithm implemented in the flight control processor 124 may process not just the inceptor command data, but may also process feedback data (e.g., position feedback) supplied via the effector control electronics 102, inertial data, and air data to implement its functionality. Thus, as FIG. 1 also depicts, the fly-by-wire flight control system 100 also preferably includes one or more inertial data sources 126 and one or more air data sources 128. The inertial data source(s) 126, which may be implemented using any one of numerous known inertial data sources, is in operable communication with, and is configured to supply inertial data to, the flight control computers 104. The air data source(s) 128, which may be implemented using any one of numerous known air data sources, is in operable communication with, and configured to supply air data to, the flight control computers 104.

The inceptor(s) 106 is in operable communication with the effector control electronics 102 and the flight control computers 104. The inceptor(s) 106 is configured to supply the inceptor data to the flight control computers 104. The inceptor(s) 106 is preferably configured to supply the inceptor data in response to user input from a user (e.g., a pilot). It will be appreciated that the inceptor(s) 106 may be variously configured and implemented. For example, the inceptor(s) 106 may be implemented as a yoke, a side stick, a collective, and/or a rudder pedal, just to name a few non-limiting examples.

No matter how the inceptor(s) 106 is specifically implemented, each is configured as a digital inceptor and includes a suitable digital bus transceiver 132 and an inceptor processor 134. The digital bus transceiver 132, which may be implemented using any one of numerous suitable transceivers, is configured to facilitate communication with the digital communication bus 108. The inceptor processor 134 is configured to implement suitable inceptor algorithm that converts the movements of the inceptor 106 (in response to user input) to the inceptor data. The inceptor processor 134 may be implemented using suitably programmed general-purpose processor, an application specific processor, a programmable logic device (PLD), or a field programmable gate array (FPGA), just to name a few non-limiting examples.

Although it is highly unlikely, it is nonetheless postulated that the flight control computers 104 could fail or otherwise become inoperable. Such inoperability could result from, for example, degraded sensor data, power failures, device failures, or common mode failures, just to name a few causes. As such, and as was previously noted, aircraft flight control systems are required to implement a backup control function to provide at least minimal functionality to safely maneuver and land the aircraft. As will now be described, the backup flight control functionality for the fly-by-wire flight control system 100 described herein is implemented in the inceptor(s) 106.

Because the inceptor(s) 106 includes an inceptor processor 134, the inceptor(s) 106 is also be configured to selectively implement the backup flight control function. As such, the inceptor processor 134 may also be referred to as the backup flight control processor 134. More specifically, when the flight control computers 104 are determined to be inoperable, a backup control mode signal, which indicates that the flight control computers 104 are inoperable, is supplied to the backup flight control processor 134. The backup flight control processor 134, in response to the backup control mode signal, is configured to selectively generate and supply the effector-specific flight control command data to the appropriate effector control electronics 102. As FIG. 1 further depicts, the inceptor(s) 106 may additionally include one or more low-fidelity sensors such as, for example, MEMS inertial sensors 136 to detect the desired axes of motion (e.g., pitch, roll, yaw), Flight Path Angle, speed control, speed set point, etc.

In the depicted embodiment, the effector control electronics 102 are configured, using known logic, to determine that the flight control computers 104 are inoperable. In some embodiments, the effector control electronics 102 are further configured, in response to determining that the flight control computers are inoperable, to supply the backup control mode signal to the inceptor(s) 106. In other embodiments, the inceptor(s) 106 includes a backup mode switch 138 that is configured, in response to user input, to generate and supply the backup control mode signal. With this embodiment, the effector control electronics 102 may be further configured, in response to determining that the flight control computers 104 are inoperable, to generate and supply an alert signal, thereby alerting the user to activate the backup mode switch 138. In still another embodiment, the flight control system 100 may include both functions. That is, the effector control electronics 102 may be configured to determine that the flight control computers 104 are inoperable and, in response, generate and supply an alert signal and the backup mode control signal, and the inceptor(s) 106 may include the backup mode switch 138.

Regardless of the source of the backup mode control signal, it is noted that the effector control electronics 102 are also configured to select the flight control commands from the inceptor(s) 106 when the backup flight control processor 134 is in the backup control mode and otherwise selects from the flight control commands from the flight control computers 104. The effector control electronics 102 are also configured to synchronize the commands (whether from the flight control computers 104 or the inceptor(s) 106) with other effector control electronics 102 if required, and to monitor closed loop control.

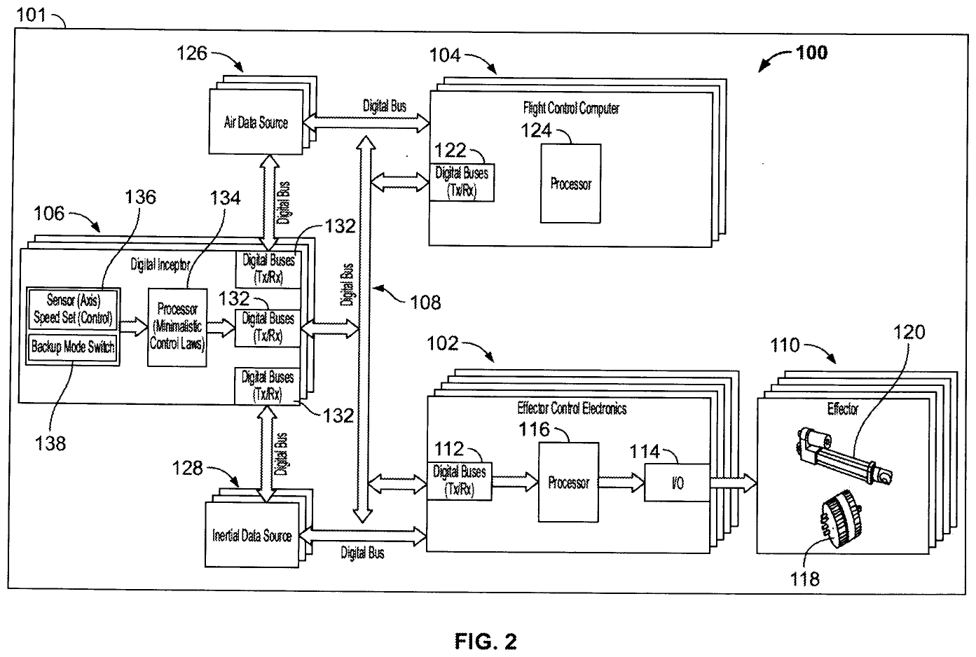

In the embodiment depicted in FIG. 1, the backup control functionality implemented in the backup flight control processor 134 is relatively simple, merely providing inceptor-to-surface control. In another embodiment, which is depicted in FIG. 2, the backup control functionality implemented in the backup flight control processor 134 may be slightly more complex, by providing the capability to control, divert, and land the aircraft. As FIG. 2 depicts, for this embodiment, the inertial data source 126 and the air data source 128 are in operable communication with, and supply the inertial data and air data, respectively, to the backup control surface processor 134.

The fly-by-wire flight control system 100 disclosed herein does not significantly increase overall system weight, space, power, size, and cost, and is not susceptible to being lost simultaneously with the loss of a flight control computer.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A fly-by-wire flight control system, comprising:
a plurality of effector control electronics, each effector control electronics coupled to selectively receive effector-specific flight control command data, each effector control electronics configured, upon receipt of its effector-specific flight control command data, to generate and supply flight control surface commands to one or more effectors;
a plurality of flight control computers, each flight control computer coupled to receive inceptor command data and configured, upon receipt of the inceptor data, to at least selectively generate and supply the effector-specific flight control command data; and
an inceptor in operable communication with each effector control electronics and each flight control computer, the inceptor configured to supply the inceptor data to the flight control computers, the inceptor comprising a backup flight control processor that is configured to:
receive a backup control mode signal indicating that the flight control computers are inoperable; and
in response to the backup control mode signal, to selectively generate and supply the effector-specific flight control command data.

2. The system of claim 1, wherein each effector control electronics is configured to (i) select the flight control commands from the inceptor in backup control mode and otherwise selects from the flight control computers, (ii) synchronize the commands with other effector control electronics if required, and (iii) monitor closed loop control.

3. The system of claim 1, wherein the inceptor further comprises:
one or more inertial sensors, each of the one or more inertial sensors in operable communication with the backup control surface processor and configured to supply inertial data thereto.

4. The system of claim 1, further comprising:
an inertial data source in operable communication with, and configured to supply inertial data to, the flight control computers and the backup flight control processor; and
an air data source in operable communication with, and configured to supply air data to, the flight control computers and the backup flight control processor.

5. The system of claim 1, wherein:
the flight control effectors are further configured to determine that the flight control computers are inoperable and, in response, supply the backup control mode signal.

6. The system of claim 1, wherein:
the effector control electronics are further configured to determine that the flight control computers are inoperable and, in response, generate and supply an alert signal; and
the inceptor further comprises a backup mode switch that is configured, in response to user input, to generate and supply the backup control mode signal.

7. The system of claim 1, wherein:
the effector control electronics are further configured to determine that the flight control computers are inoperable and, in response, generate and supply an alert signal and the backup mode control signal; and
the inceptor further comprises a backup mode switch that is configured, in response to user input, to generate and supply the backup control mode signal.

8. A vehicle, comprising:
a vehicle body; and
a fly-by-wire flight control system disposed within the vehicle body, the fly-by-wire flight control system comprising:
a plurality of effector control electronics, each effector control electronics coupled to selectively receive effector-specific flight control command data, each effector control electronics configured, upon receipt of its effector-specific flight control command data, to generate and supply flight control surface commands to one or more flight control effectors;
a plurality of flight control computers, each flight control computer coupled to receive inceptor command data and configured, upon receipt of the inceptor data, to at least selectively generate and supply the effector-specific flight control command data; and
an inceptor in operable communication with each effector control electronics and each flight control computer, the inceptor configured to supply the inceptor data to the flight control computers, the inceptor comprising a backup flight control processor that is configured to:
receive a backup control mode signal indicating that the flight control computers are inoperable; and
in response to the backup control mode signal, to selectively generate and supply the effector-specific flight control command data.

9. The aircraft of claim 8, wherein each effector control electronics is configured to (i) select the flight control commands from the inceptor in backup control mode and otherwise selects from the flight control computers, (ii) synchronize the commands with other effectors if required, and (iii) monitor closed loop control.

10. The aircraft of claim 8, wherein the inceptor further comprises:
one or more inertial sensors, each of the one or more inertial sensors in operable communication with the backup control surface processor and configured to supply inertial data thereto.

11. The aircraft of claim 8, further comprising:
an inertial data source in operable communication with, and configured to supply inertial data to, the flight control computers and the backup flight control processor; and
an air data source in operable communication with, and configured to supply air data to, the flight control computers and the backup flight control processor.

12. The aircraft of claim 8, wherein:
the effector control electronics are further configured to determine that the flight control computers are inoperable and, in response, supply the backup control mode signal.

13. The aircraft of claim 8, wherein:
the effector control electronics are further configured to determine that the flight control computers are inoperable and, in response, generate and supply an alert signal; and
the inceptor further comprises a backup mode switch that is configured, in response to user input, to generate and supply the backup control mode signal.

14. The aircraft of claim 8, wherein:
the effector control electronics are further configured to determine that the flight control computers are inoperable and, in response, generate and supply an alert signal and the backup mode control signal; and
the inceptor further comprises a backup mode switch that is configured, in response to user input, to generate and supply the backup control mode signal.

15. A fly-by-wire flight control system, comprising:
a plurality of effector control electronics, each effector control electronics coupled to selectively receive effector-specific flight control command data, each effector control electronics configured, upon receipt of its effector-specific flight control command data, to generate and supply flight control surface commands to one or more effectors;
a plurality of flight control computers, each flight control computer coupled to receive inceptor command data and configured, upon receipt of the inceptor data, to at least selectively generate and supply the effector-specific flight control command data; and
an inceptor in operable communication with each effector control electronics and each flight control computer, the inceptor configured to supply the inceptor data to the flight control computers, the inceptor comprising a backup flight control processor that is configured to: (i) receive a backup control mode signal indicating that the flight control computers are inoperable and (ii) in response to the backup control mode signal, to selectively generate and supply the effector-specific flight control command data,
wherein each effector control electronics is further configured to (i) determine that the flight control computers are inoperable (ii) select the flight control commands from the inceptor in backup control mode and otherwise select from the flight control computers, (iii) synchronize the commands with other effector control electronics if required, and (iv) monitor closed loop control.

16. The system of claim 15, wherein the inceptor further comprises:
one or more inertial sensors, each of the one or more inertial sensors in operable communication with the backup control surface processor and configured to supply inertial data thereto.

17. The system of claim 15, further comprising:
an inertial data source in operable communication with, and configured to supply inertial data to, the flight control computers and the backup flight control processor; and
an air data source in operable communication with, and configured to supply air data to, the flight control computers and the backup flight control processor.

18. The system of claim 15, wherein:
the effector control electronics are further configured, upon determining that the flight control computers are inoperable, to supply the backup control mode signal.

19. The system of claim 15, wherein:
the effector control electronics are further configured , upon determining that the flight control computers are inoperable, to generate and supply an alert signal; and
the inceptor further comprises a backup mode switch that is configured, in response to user input, to generate and supply the backup control mode signal.

20. The system of claim 15, wherein:
the effector control electronics are further configured, upon determining that the flight control computers are inoperable, to generate and supply an alert signal and the backup mode control signal; and
the inceptor further comprises a backup mode switch that is configured, in response to user input, to generate and supply the backup control mode signal.
